(19) United States
(12) Patent Application Publication
(10) Pub. No.: US 2024/0198358 A1
(43) Pub. Date: Jun. 20, 2024

(54) DUST COLLECTOR

(71) Applicant: BEIANG AIR TECH LTD., Suzhou (CN)

(72) Inventors: Hongyu RAN, Suzhou (CN); Yan ZHANG, Suzhou (CN); Yigang LIU, Suzhou (CN); Yaoyuan LU, Suzhou (CN); Hongqiang LI, Suzhou (CN)

(21) Appl. No.: 17/794,601

(22) PCT Filed: Nov. 12, 2021
(86) PCT No.: PCT/CN2021/130279

§ 371 Date: Oct. 20, 2022

(30) Foreign Application Priority Data
Apr. 14, 2021 (CN) 202110403281.5

(51) Int. Cl. B03C 3/51; B03C 3/47

(52) U.S. Cl. CPC B03C 3/51; B03C 3/47

(57) ABSTRACT

A dust collector includes a base body having a receiving chamber formed therein; a separator provided in the receiving chamber to form a plurality of first slots and a plurality of second slots arranged at intervals, the first slot is positioned at one side of the separator and the second slot is positioned at the other side of the separator; a repelling module including a plurality of repeller plates arranged in parallel, which are disposed in the plurality of first slots; and a collecting module including a first collection unit and a second collection unit arranged, the first collection unit including a plurality of first collector plates arranged in parallel, the second collection unit including a plurality of second collector plates arranged in parallel; the first collection unit and the second collection unit are detachably inserted and the first and second collector plates are arranged at an interval.

### CROSS-REFERENCES TO RELATED APPLICATIONS

This patent application claims priority to Chinese patent application 202110403281.5 filed on Apr. 14, 2021, the entirety of which is incorporated herein by reference.

### FIELD OF THE INVENTION

This application relates to the technical field of air purification devices, and more particularly to a dust collector.

### DESCRIPTION OF THE RELATED ART

Air purification devices based on electrostatic dust collection techniques generally include a generator and a collector disposed between the air inlet and the air outlet. The generator is used to ionize air molecules to be positively charged, and the air molecules collide with other particles in the process of flowing to the air outlet to make them positively charged, so that other particles in the air, such as dust or the like, are finally adsorbed by the negatively charged collector. The collector includes a collecting module and a repelling module. The collecting module includes a plurality of collector plates arranged at an interval, and the repelling module includes a plurality of repeller plates arranged at an interval. The plurality of collector plates are inserted in the intervals between the plurality of repeller plates and vice versa. The collector plates are negatively charged for adsorption, and the repeller plates are positively charged for repulsion. When dust passes through the collector, it moves toward the collector plates under the combined action of adsorption force and repulsion force.

After the air purification device has been used for a period of time, it is necessary to remove the collecting module for cleaning and dust removal. As the interval space between the collector plates on the collecting module is small, it is inconvenient to maneuver in the interval to clean the surface of the collector plates after disassembly. However, after cleaning, some collector plates may enter the same interval as the adjacent collector plates due to deformation or external force during assembly, such that the collector plate at this position is pressed against the repeller plate, resulting in the phenomenon of sparking. Therefore, there is an urgent need for a dust collector which is easy to clean and has high assembly error tolerance.

### SUMMARY OF THE INVENTION

This application is intended to provide a dust collector that is easy to clean and has high assembly error tolerance.

Embodiment of this application are implemented as follows.

In a first aspect, an embodiment of this application provides a dust collector including:
a base body having a receiving chamber formed therein;
a separator provided in the receiving chamber to form a plurality of first slots and a plurality of second slots arranged at an interval, the first slot being positioned at one side of the separator and the second slot being positioned at the other side of the separator;
a repelling module including a plurality of repeller plates arranged in parallel, the plurality of repeller plates being disposed in the plurality of first slots; and
a collecting module including a first collection unit and a second collection unit arranged in parallel, the first collection unit including a plurality of first collector plates arranged in parallel, the second collection unit including a plurality of second collector plates arranged in parallel; the first collection unit and the second collection unit being detachably inserted and the plurality of first collector plates and the plurality of second collector plates being arranged at an interval; the collecting module being detachably connected to the base body, so that the plurality of first collector plates and the plurality of second collector plates being inserted respectively into the plurality of second slots.

In an embodiment of this application, for the ease of cleaning, the collecting module is provided as a first collection unit and a second collection unit that are detachably inserted. Once the collecting module is detached, the first collection unit and the second collection unit are disconnected, so that the space between adjacent collector plates is increased, and maneuvers may be made and the surface of the collector plate may be cleaned in the space. Although this arrangement further requires a step of assembly after cleaning and may increase the assembly error rate, as the collecting module is separated from the repelling module by the separator in the base body, and the collector plates and the repeller plates are positioned respectively at two sides of the separator, sparking due to assembly error can be prevented.

That is, in this application, the combination of a split-type collecting module and a base body with a separator prevents sparking due to improper assembly between the first collection unit and the second collection unit as well as sparking due to improper assembly between the collecting module and the repelling module, so that the assembly error can be neglected to present high assembly error tolerance, thereby allowing convenient assembly and easy cleaning.

In an embodiment of this application, the first collector plate and the second collector plate are both metal plates.

Since metal plates are susceptible to deformation, which often leads to assembly errors, collector plates from prior art are typically made of carbon fiber reinforced resin plates. In contrast to prior art, in the technical solution described above, metal plates can be used as the first collector plate and the second collector plate in the case of high assembly error tolerance. Metal plates have small resistance and uniform surface resistance, thereby proving improved dust collecting efficiency compared with carbon fiber reinforced resin plates. Also, metal plates have a smooth surface, thereby facilitating cleaning and air drying.

In an embodiment of this application, each collection unit includes two connection plates positioned at two ends of the long side of the plurality of collector plates respectively and connected to the short side of the plurality of collector plates respectively.

In the technical solution described above, the collector plates in each collection unit can each be separately detached and replaced, thereby having reduced repair cost. If one of the collector plates is improperly assembled, it can be detached and reinstalled, thereby further improving the assembly error tolerance.

In an embodiment of this application, at least one long side of each collector plate is provided with a circular tube, the circular tube has an axial direction parallel to the extension direction of the long side and an outer surface connected to the long side.

In the technical solution described above, the circular tube increases the structural strength of the collector plates, making the collector plates less susceptible to deformation and reducing the assembly error rate.

In an embodiment of this application, the receiving chamber includes a first side wall, a second side wall, a third side wall and a fourth side wall that are connected end-to-end in sequence. The first side wall and the second side wall are disposed opposite to each other, the third side wall and the fourth side wall are disposed opposite to each other, and the first side wall and the second side wall each is provided with the separator.

In the technical solution described above, the collecting module can be entirely inserted into the receiving chamber to allow each of the collector plates to be positioned within the second slot, thereby allowing convenient assembly.

In an embodiment of this application, the first side wall and the second side wall have a length greater than the length of the third side wall and the fourth side wall.

In the technical solution described above, the collector plates and the repeller plates are respectively arranged along the length of the receiving chamber, so that the collector plates and the repeller plates have a relatively small length, and the collector plates have relatively large strength and are less susceptible to deformation, thereby reducing the assembly error rate.

In an embodiment of this application, each second slot has at least one pair of protrusions therein, the protrusions in each pair are disposed opposite to each other to grip the collector plate.

In the technical solution described above, the protrusions in each pair cooperate to further fix the collector plate and define the space between the repeller plate and the collector plate, and ensure a uniform space after assembly of the collector plate to allow a uniform and even electric field, thereby allowing the individual collector plates to have equivalent dust collecting efficiency, and consequently ensuring high dust collecting efficiency.

In an embodiment of this application, each protrusion includes a first surface and a second surface, the first surface faces the opening of the second slot and the second surface faces away from the opening of the second slot. The first surface is an inclined surface, the end of the first surface connected to the separator is close to the opening of the second slot and the other end of the first surface is far from the opening of the second slot.

In the technical solution described above, the first surface has the effect of guiding for guiding the collector plate to enter between the two protrusions.

In an embodiment of this application, the second surface is a curved surface.

In the technical solution described above, the second surface is a curved surface to make it easier for the protrusions to be elastically deformed and for the collector plate to squeeze the two protrusions apart and enter therebetween, and the two protrusions can better clamp the collector plate after rebounding, thereby facilitating the assembly and improving stability in assembly.

In an embodiment of this application, the second surface bends towards a direction far away from the opening of the second slot.

In the technical solution described above, the second surface bends downward, so that the collector plate can easily enter therein without easily escaping by accident, thereby improving stability in assembly.

### BRIEF DESCRIPTION OF THE DRAWINGS

In order to explain the technical solution of the embodiments of this application more clearly, the drawings that need to be used in the embodiments will be briefly introduced in the following. It should be understood that the following drawings only show some embodiments of this application, so they should not be regarded as limitation on the scope. For those of ordinary skill in the art, other relevant drawings can be obtained according to these drawings without any creative effort.

FIG. 1 is a schematic structural view of a dust collector according to an embodiment of this application;

FIG. 2 is an exploded view of a dust collector and a collecting module according to an embodiment of this application;

FIG. 3 is a sectional view of a dust collector according to an embodiment of this application;

FIG. 4 is a schematic structural view of a collecting module according to an embodiment of this application;

FIG. 5 is an exploded view of a first collection unit and a second collection unit according to an embodiment of this application;

FIG. 6 is a structural assembly view of a collecting module according to an embodiment of this application;

FIG. 7 is another structural assembly view of a collecting module according to an embodiment of this application;

FIG. 8 is yet another structural assembly view of a collecting module according to an embodiment of this application;

FIG. 9 is still another structural assembly view of a collecting module according to an embodiment of this application;

FIG. 10 is an enlarged view of the portion A; and

FIG. 11 is a schematic structural view of a repelling module according to an embodiment of this application.

### REFERENCE NUMBERS

1 base body; 11 first side wall; 12 second side wall; 13 third side wall; 14 fourth side wall; 15 separator; 151 first slot; 152 second slot; 16 collector potential connector; 17 repeller potential connector; 18 groove; 19 buckle; 2 repelling module; 21 repeller plate; 22 insulating sleeve; 23 connecting bar; 3 collecting module; 31 first collection unit; 311 first collector plate; 312 first connecting plate; 313 wing; 314 insert; 32 second collection unit; 321 second collector plate; 322 second connecting plate; 323 clamping slot; 4 circular tube; 5 protrusion; 51 first surface; 52 second surface; 100a connecting plate; 200a collector plate; 300a tongue; 400a extension; 100b connecting plate; 200b collector plate; 300b through slit; 400b extension; 100c connecting plate; 200c collector plate; 300c tongue; 400c hook; 100d connecting plate; 200d collector plate; 300d pin hole; 400d rivet.

### DETAILED DESCRIPTION OF THE PREFERRED EMBODIMENTS

In order to make the purpose, technical solution and advantages of embodiments of this application clearer, the technical solution in the embodiments of this application will be clearly and completely described below with reference to the drawings in the embodiments of this application. Obviously, the embodiments described are merely some of the embodiments of this application, but not all of them. Generally, the components of the embodiments of this application described and illustrated in the drawings herein can be arranged and designed in various different configurations.

Therefore, the following detailed description of the embodiments of this application provided in the drawings is not intended to limit the scope of the claimed application, but only to represent selected embodiments of this application. Based on the embodiments in this application, all other embodiments obtained by those of ordinary skill in the art without creative effort shall fall within the scope of protection in this application.

It should be noted that similar numbers and letters indicate similar items in the following drawings, so once an item is defined in one drawing, it does not need to be further defined and explained in subsequent drawings.

In the description of this application, it should be noted that if the orientation or positional relationship indicated by the terms “center”, “upper”, “lower”, “left”, “right”, “vertical”, “horizontal”, “inner” and “outer” or the like appears, it is based on the orientation or positional relationship shown in the drawings, or the orientation or positional relationship with which the product of this application is usually placed in use, and it is intended merely to facilitate description of this application and simplifying description, instead of indicating or implying that the referred apparatus or element has to have a specific orientation or be constructed and operated in a specific orientation, and therefore should not be understood as limitation on this application. In addition, if the terms “first” and “second” or the like appear in the description of this application, they are merely intended for distinguishment in the description, and should not be understood as indicating or implying relative importance.

In addition, if the terms “horizontal” and “vertical” or the like appear in the description of this application, it does not mean that the components have to be absolutely horizontal or overhanging, but can be slightly inclined. For example, the term “horizontal” only means that its direction is more horizontal than the term “vertical”, which does not mean that the structure has to be completely horizontal, but can be slightly inclined.

In the description of this application, it should also be noted that unless otherwise specified and defined, the terms “set”, “installed”, “joined” and “connected” should be understood broadly, for example, they can be fixed, detachable or integrally connected; be mechanically connected or electrically connected; be directly connected or indirectly connected through an intermediate medium, or it can be the internal communication between two elements. For those of ordinary skill in the art, the specific meanings of the above terms in this application can be understood in specific situations.

### Embodiments

This application provides a dust collector having the characteristics of easy cleaning as well as high assembly error tolerance, so that this dust collector can be disassembled and cleaned at any time and can be conveniently assembled after cleaning, and sparking due to assembly errors is unlikely to occur.

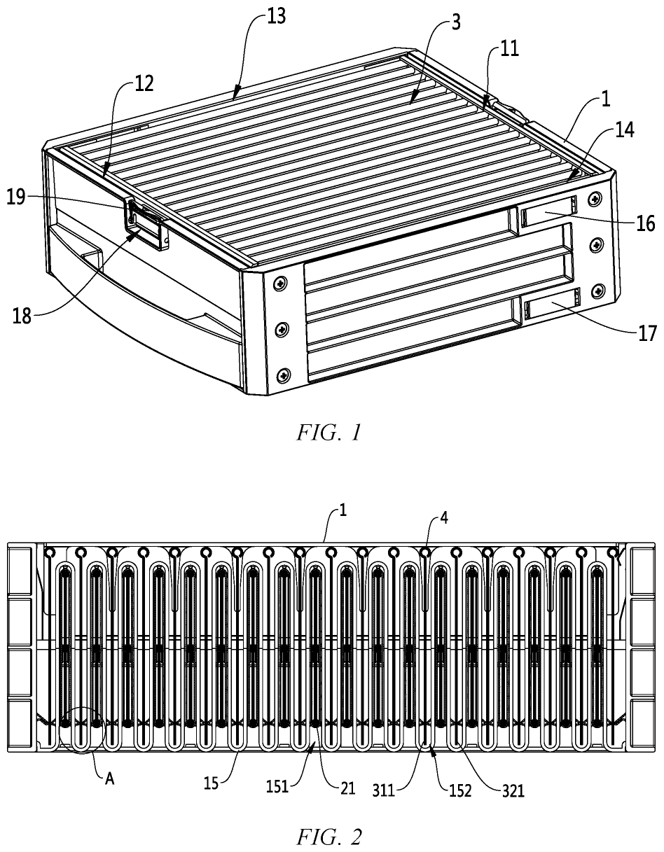

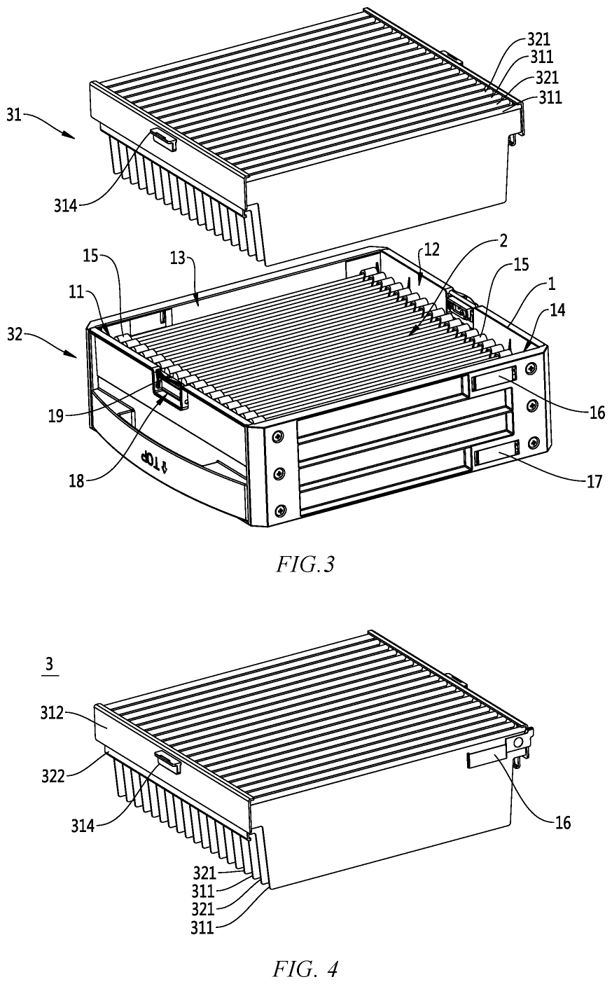

As shown in FIGS. 1 and 2, the dust collector includes a base body 1, a repelling module 2 and a collecting module 3.

The base body 1 has a receiving chamber formed therein. The receiving chamber includes a first side wall 11, a second side wall 12, a third side wall 13 and a fourth side wall 14 that are connected end-to-end in sequence. The first side wall 11 is opposite to the second side wall 12 and the third side wall 13 is opposite to the fourth side wall 14.

As shown in FIG. 3, the first side wall 11 and the second side wall 12 are each provided with a separator 15 that protrudes from the surface of the side wall where it is situated, and the separator 15 is S-shaped to form a plurality of first slots 151 and a plurality of second slots 152 that are arranged at an interval.

The first slot 151 is positioned at one side of the separator 15 and the second slot 152 is positioned at the other side of the separator 15.

The repelling module 2 includes a plurality of repeller plates 21 arranged in parallel, and the repeller plates 21 are each disposed in the first slot 151.

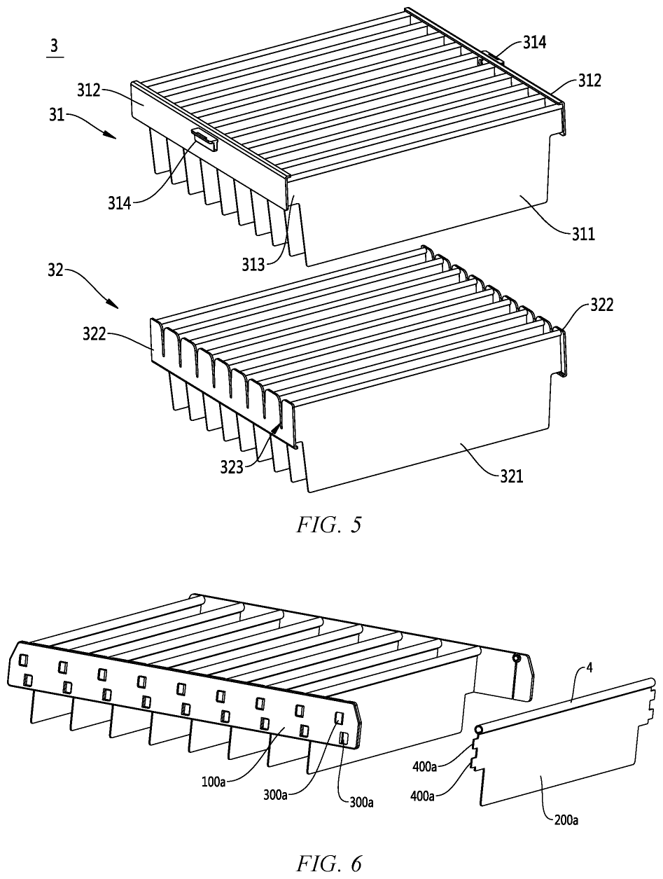

The collecting module 3 is detachably connected to the base body 1. As shown in FIGS. 4 and 5, the collecting module 3 includes a first collection unit 31 and a second collection unit 32.

The first collection unit 31 includes a plurality of first collector plates 311 arranged in parallel. The space between adjacent first collector plates 311 is 2 L. The second collection unit 32 includes a plurality of second collector plates 321 arranged in parallel. The space between adjacent second collector plates 321 is 2 L.

The first collector plates 311 and the second collector plates 321 referred to in embodiments of this application are both collector plates that are negatively charged to serve as structures for collecting particles such as dust or the like.

The first collection unit 31 and the second collection unit 32 are detachably inserted to allow a plurality of first collector plates 311 to be inserted into the intervals between a plurality of second collectors plate 321. The space between a first collector plate 311 and an adjacent second collector plate 321 is L.

When the collecting module 3 is connected to the base body 1, each collector plate is inserted into the second slot 152, so that the plurality of collector plates and the plurality of repeller plates 21 are arranged at interval in a staggered manner.

When the dust collector according to embodiments of this application needs to be cleaned, first the collecting module 3 is detached from the base body 1, then the collecting module 3 is split into the first collection unit 31 and the second collection unit 32, so that the space between the collector plates is increased from L to 2 L, thereby facilitating reaching into the space with a tool such as a brush, a rag or the like to clean the surface of the collector plates.

After cleaning is done, and before the collecting module 3 is assembled to the base body 1, first the first collection unit 31 and the second collection unit 32 need to be assembled into a collecting module 3. As an assembly step is added after split-up, assembly errors tend to occur where the first collector plates 311 and the second collector plates 321 are not inserted at intervals in a staggered manner. In the case of an assembly error, two collector plates may possibly both be positioned between two repeller plates 21, which tends to cause sparking.

That is, first an assembly error occurs during assembly of the first collection unit 31 with the second collection unit 32, then an assembly error occurs during assembly of the collecting module 3 with the base body 1. Therefore, there are two chances for an assembly error to occur, so that the assembly error rate may be increased.

The combination of this split-type collecting module 3 with the separator 15 according to this embodiment can solve the problem of increased assembly error rate. As the collecting module 3 is separated from the repelling module 2 in the receiving chamber by the separator 15 and the collector plates and the repeller plates 21 are positioned respectively at two sides of the separator 15, there will be no contact between the collector plates and the repeller plates 21 even in the case of an assembly error for the collector plates, thereby preventing sparking.

Therefore, the dust collector according to this application has high error tolerance, thereby effectively solving the problem of high assembly error rate for the split-type collecting module 3 and consequently having the effects of both convenient cleaning and easy assembly.

Optionally, the first side wall 11 and the second side wall 12 have a length greater than the length of the third side wall 13 and the fourth side wall 14. The collector plates and the repeller plates 21 are arranged respectively along the length of the receiving chamber in such a manner that the length of the collector plates and the repeller plates 21 can be set relatively small to increase the structural strength of the collector plates, making it less susceptible to deformation, thereby reducing the assembly error rate.

Considering the problem that metal plates are susceptible to deformation, sparking due to assembly error occurs even more often in collector plates made of metal plates for a split-type collecting module 3. It remains a technical hindrance in the art to solve the problem of sparking in metal collector plates. Therefore, in prior art, collector plates are generally made of carbon fiber reinforced resin plates.

Carbon fiber reinforced resin plates are formed by solidification of conductive fiber such as carbon fiber, metal fiber or the like with resin base material. Although at a macroscopic level, conduction of the plate is achieved through bridging and transition or the like by the conductive fiber, at a microscopical level, resin coating causes uneven surface resistance of the collector plate, so that non-conductive sites are present on the surface of the collector plate, which reduces corona efficiency of the polar pair and polar plates as well as the dust collecting efficiency of the collector plate. Experiments show that the dust collecting efficiency is reduced by 5% to 10%.

In contrast to prior art, the collector plates are made of metal plates in embodiments of this application. As the dust collector according to this embodiment has high assembly error tolerance, sparking due to assembly error are unlikely to occur even if metal plates are used.

The collector plates according to embodiments of this application provide increased dust collecting efficiency as they are metal plates, which have characteristics of small resistance and uniform resistance. Meanwhile, the surface of the collector plates is smoother and has better hydrophobicity, so that particles such as dusts attached to the surface can be cleaned more easily. After cleaning, only a small amount of waterdrops remains on the surface of the collector plate, so that the surface can be dried in the air at a room temperature of 25° ° C. for 10 to 30 minutes or directly dried by wiping with a dry towel and is then ready for use.

The collector plates may be formed from metal plates by forging to obtain smaller thickness, thereby further reducing the resistance and improving the dust collecting efficiency.

A circular tube 4 is provided on at least one long side of the collector plates, the circular tube 4 has an axial direction parallel to the extension direction of the long, and an outer surface of the circular tube 4 is connected to the long side to improve the structural strength of the collector plates, making the collector plates less susceptible to deformation and consequently reducing the assembly error rate.

The circular tube 4 is integrally formed with the collector plates. For example, in the case where the collector plates are made of metal plates, the edge of the long side is curled to form the circular tube 4.

Alternatively, the circular tube 4 may be separately formed and welded to the edge of the long side of the collector plates.

In the case where the collector plates are made of carbon fiber reinforced resin material, the whole collecting module 3 is typically integrally molded from the carbon fiber reinforced resin material. Once any individual collector sheet in the collecting module 3 is damaged, the whole collecting module 3 needs to be replaced.

Each collection unit in this embodiment includes two collector plates that are respectively positioned at the two ends of the long side of the plurality of collector plates and connected to the short side of the plurality of collector plates. Each collector plate in each collection unit can be separately detached. In this way, if a certain collector plate is improperly assembled, it can be detached and reinstalled, thereby improving the assembly error tolerance. If a certain collector plate is damaged or cannot be cleaned up, it can be separately detached, thereby reducing the repair cost.

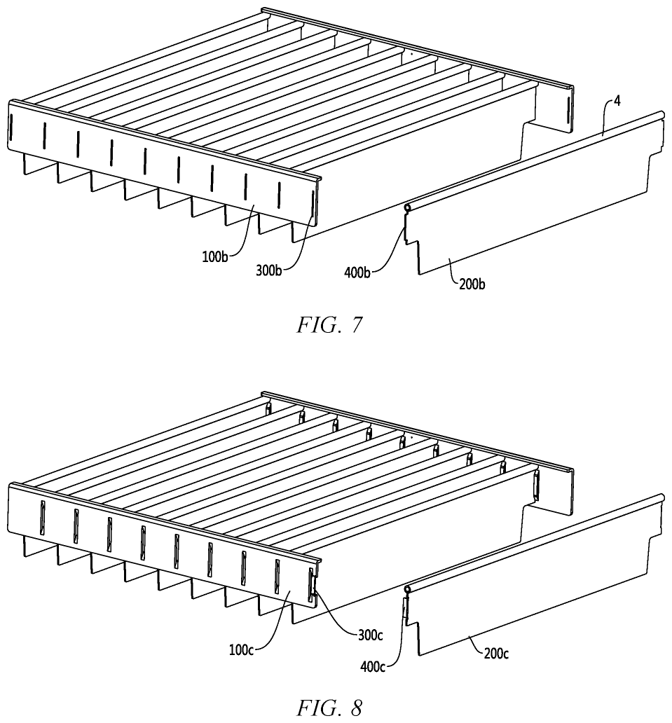

FIG. 6 shows an assembly structural view of the collecting module 3, in which two tongues 300a are formed on the connecting plate 100a. The two tongues 300a are extended in opposite directions towards the two ends of the connecting plate 100a respectively. Two extensions 400a are formed at one end of the collector plate 200a. The two extensions 400a are bent in opposite directions and then hooked to and fixed to the two tongues 300a with press rivets respectively.

FIG. 7 shows another assembly structural view of the collecting module 3, in which a through slit 300b is formed on the connecting plate 100b. An extension 400b is formed on one end of the collector plate 200b. The extension 400b is connected to the through slit 300b by using the insertion slit and press rivet process.

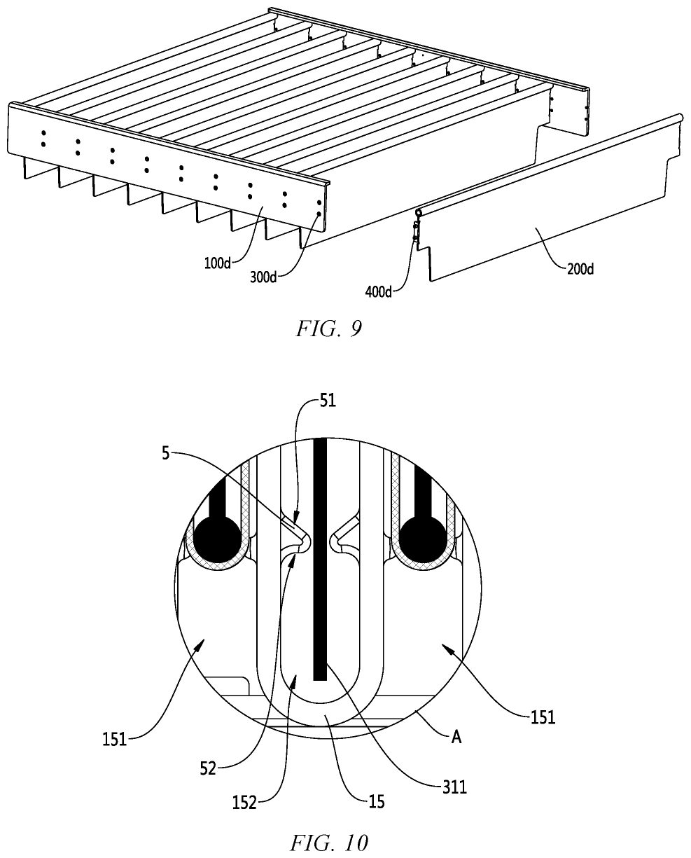

FIG. 8 shows another assembly structural view of the collecting module 3. A tongue 300c is formed on the connecting plate 100c. The tongue 300c is extended toward one end of the connecting plate 100c. A hook 400c is formed on one end of the collector plate 200c. The hook 400c is hooked to the tongue 300c and fixed with a press rivet.

FIG. 9 shows yet another assembly structural view of the collecting module 3. A pin hole 300d is formed on the connecting plate 100d. A rivet 400d is formed on one end of the collector plate 200d. The rivet 400d is connected to the pin hole 300d by using the pin hole and rise rivet process.

The first collection unit 31 includes two first connecting plates 312 that are respectively positioned at two ends of the long side of the plurality of first collector plates 311 and are respectively detachably connected to the short side of the plurality of collector plates. The second collection unit 32 includes two second connecting plates 322 that are respectively positioned at two ends of the long side of the plurality of second collector plates 321 and are respectively detachably connected to the short side of the plurality of collector plates. The first collection unit 31 and the second collection unit 32 are connected and formed in any of the connection manners shown in FIGS. 6-9, but may alternatively be connected in other manners.

In some embodiments, the first collector plate 311 is T-shaped, so that a wing 313 is formed at both ends of the first collector plate 311, and a clamping slot 323 is formed on the second connecting plate 322 for receiving the wing 313 so as to facilitate assembly between the first collection unit 31 and the second collection unit 32.

Referring again to FIG. 5, the wing 313 is provided at an upper position along the short side of the first collector plate 311, and the first connecting plate 312 is connected to the wing 313; and the second connecting plate 322 is positioned at an upper position along the short side of the second collector plate 321, and the clamping slot 323 on the second connecting plate 322 has an opening facing upward to allow entry of the wing 313 of the first connecting plate 312.

The first connecting plate 312 and the second connecting plate 322 have conductive material, so that various collector plates are connected in parallel and conducted, and the collector potential connector 16 on the base body 1 are conducted both with the first connecting plate 312 and with the second connecting plate 322. Optionally, the first connecting plate 312 is pressed against the side of the second connecting plate 322 far from the second collector plate 321 to increase stability in connection and facilitate connection with the collector potential connector 16.

In some embodiments, a groove 18 is formed on the base body 1. The groove 18 extends through the side wall of the receiving chamber. A buckle 19 is provided in the groove 18. An insert 314 is formed on the first connecting plate 312. The insert 314 is intended to be inserted into the groove 18, and the buckle 19 is intended to restrain the insert 314 from escaping upward, so that the base body 1 and the collecting module 3 are fixed to each other.

The buckle 19 is of a U-shape. Both arms of the U-shape are connected to the side wall of the groove 18 via a torsion spring and close the opening of the groove 18.

With reference to FIGS. 1 and 3, the two first connecting plates 312 correspond respectively to the first side wall 11 and the second side wall 12 of the receiving chamber, and a buckle 19 is provided on each of the first side wall 11 and the second side wall 12.

After the first collection unit 31 and the second collection unit 32 are assembled into the collecting module 3, the collecting module 3 is placed in the receiving chamber. The plurality of first collector plates 311 and the plurality of second collector plates 321 enter respectively the plurality of second slots 152. Meanwhile, the insert 314 on the first connecting plate 312 presses the buckle 19 to enter the groove 18. The buckle 19 is restored to restrain the collecting module 3 from being disconnected from the base body 1.

In some embodiments, a plurality of protrusions 5 are formed on the separator 15. As shown in FIG. 10, each second slot 152 has a pair of protrusions 5. The protrusions 5 in each pair are disposed opposite to each other to grip the collector plate.

Once gripped by the pair of protrusions 5, the collector plate is unlikely to swing in the second slot 152, so that the collector plates are assembled with an even space therebetween, each collector plate is separated from an adjacent repeller plate 21 by a defined space, thereby forming an even and uniform electric field. As such, the various collector plates have equivalent dust collecting efficiency, thereby avoiding the case where any individual collector plate has very low dust collecting efficiency and consequently the overall dust collecting efficiency is reduced, thus high dust collecting efficiency can be ensured.

Each protrusion 5 includes a first surface 51 and a second surface 52 that are connected to each other. The first surface 51 is positioned on the side of the protrusion 5 close to the opening of the second slot 152, and the second surface 52 is positioned on the side of the protrusion 5 facing away from the opening of the second slot 152.

The first surface 51 is configured as an inclined surface. The end of the first surface 51 connected to the separator 15 is relatively close to the opening of the second slot 152 and the end of the first surface 51 connected to the second surface 52 is relatively far from the opening of the second slot 152.

The first surfaces 51 of the two protrusions 5 are intended to guide the collector plate to enter between the two protrusions 5 to reduce the resistance in assembly, thereby facilitating quick assembly.

The second surface 52 is configured as a curved surface to enable the protrusions 5 to have good elastic deformation capability, making it easier for the collector plate to squeeze the two protrusions 5 apart and enter therebetween. Once restored, the two protrusions 5 can better grip the collector plate, thereby facilitating assembly and increasing stability in assembly.

Optionally, the second surface 52 bends downward. That is, the second surface 52 bends towards a direction far away from the opening of the second slot 152. The axis line of the second surface 52 is positioned at the side of the protrusion 5 far from the opening of the second slot 152. This makes it easy for the protrusions 5 to be deformed downward and relatively uneasy to be deformed upward, and makes it easy for the collector plate to slip into between the two protrusions 5 along the first surface 51. However, when the collector plate is moving towards the opening of the second slot 152, the two protrusions 5 can seize the collector plate tightly, so that the collector plate are unlikely to escape, but rather it has to be exerted with some external force to be pulled out, thereby increasing stability in assembly.

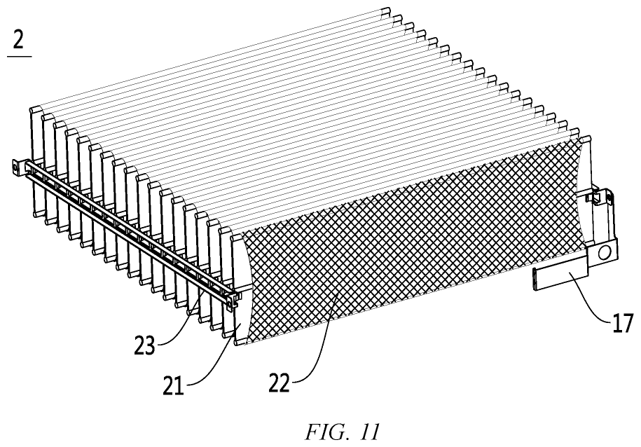

To further prevent sparking, as shown in FIG. 11, each repeller plate 21 is provided with an insulating sleeve 22.

The insulating sleeve 22 is sleeved over the repeller plate 21 by the thermal shrinkage process, so that both side faces of the repeller plate 21 are covered with an insulating material, leaving only the ends of the repeller plate 21 exposed. The ends of the repeller plate 21 are conducted in parallel via a connecting bar 23 so as to be connected and installed to the repeller potential connector 17 in the base body 1. As the ends of the repeller plate 21 are mainly inserted in the first slot 151 and the middle portion of the repeller plate 21 is wrapped by the insulating bush 22, the chance of sparking due to contact between the repeller plate 21 and the collector plate is further reduced.

Descried above are merely preferred embodiments of this application, and these are not intended as limitation on this application. For those skilled in the art, this application can have various modifications and variations. Any modification, equivalent substitution, improvement or the like made within the spirit and principle of this application shall fall within the scope of protection of this application.

What is claimed is:

1. A dust collector, comprising:
a base body having a receiving chamber formed therein;
a separator provided in the receiving chamber to form a plurality of first slots and a plurality of second slots arranged at intervals, the first slot being positioned at one side of the separator and the second slot being positioned at the other side of the separator;
a repelling module including a plurality of repeller plates arranged in parallel, the plurality of repeller plates being disposed in the plurality of first slots; and
a collecting module including a first collection unit and a second collection unit arranged in parallel, the first collection unit including a plurality of first collector plates arranged in parallel, the second collection unit including a plurality of second collector plates arranged in parallel; the first collection unit and the second collection unit being detachably inserted and the plurality of first collector plates and the plurality of second collector plates being arranged at intervals; the collecting module being detachably connected to the base body, so that the plurality of first collector plates and the plurality of second collector plates being inserted respectively into the plurality of second slots.

2. The dust collector of claim 1, wherein the first collector plate and the second collector plate are both metal plates.

3. The dust collector of claim 2, wherein each collection unit includes two connection plates positioned at two ends of the long side of the plurality of collector plates respectively and connected to the short side of the plurality of collector plates respectively.

4. The dust collector of claim 1, wherein at least one long side of each collector plate is provided with a circular tube having an axial direction parallel to the extension direction of the long side and an outer surface connected to the long side.

5. The dust collector of claim 1, wherein the receiving chamber includes a first side wall, a second side wall, a third side wall and a fourth side wall that are connected end-to-end in sequence, the first side wall and the second side wall being disposed opposite to each other, the third side wall and the fourth side wall being disposed opposite to each other, and the first side wall and the second side wall each being provided with the separator respectively.

6. The dust collector of claim 5, wherein the first side wall and the second side wall have a length greater than the length of the third side wall and the fourth side wall.

7. The dust collector of claim 1, wherein each second slot has at least one pair of protrusions therein, the protrusions in each pair being disposed opposite to each other to grip the collector plate.

8. The dust collector of claim 7, wherein each protrusion includes a first surface and a second surface, the first surface facing an opening of the second slot and the second surface facing away from an opening of the second slot; the first surface being an inclined surface, an end of the first surface connected to the separator being close to the opening of the second slot, and the other end of the first surface being far from the opening of the second slot.

9. The dust collector of claim 8, wherein the second surface is a curved surface.

10. The dust collector of claim 9, wherein the second surface bends towards a direction far away from the opening of the second slot.
